(19) United States
(12) Patent Application Publication
(10) Pub. No.: US 2019/0366780 A1
(43) Pub. Date: Dec. 5, 2019

(54) TIRE HAVING AN ELECTRONIC DEVICE IN A LOWER SIDEWALL

(71) Applicant: Bridgestone Americas Tire Operations, LLC, Nashville, TN (US)

(72) Inventors: Andrew Miklic, Akron, OH (US); Paul Wilson, Tallmadge, OH (US)

(21) Appl. No.: 16/542,493

(22) Filed: Aug. 16, 2019

Related U.S. Application Data
(62) Division of application No. 15/101,464, filed on Jun. 3, 2016, now abandoned.
(60) Provisional application No. 61/915,556, filed on Dec. 13, 2013.

(51) Int. Cl. B60C 19/00; B60C 15/06; B60C 11/00; B60C 13/00; B60C 15/00; H04B 5/00

(52) U.S. Cl. CPC B60C 19/00; B60C 15/06; B60C 15/0607; B60C 11/00; B60C 2015/0621; B60C 15/0009; B60C 15/0628; H04B 5/0062; B60C 2015/0614; B60C 13/00

(57) ABSTRACT

A tire includes a circumferential tread, a pair of sidewalls, and a pair of bead portions. Each bead portion includes a bead and a bead filler having an apex. The tire also has a body ply extending from bead portion to bead portion. The body ply includes a pair of turn up portions radially outside of a respective bead portion. The tire further has a pair of wire reinforcements. Each wire reinforcement wraps around a respective bead and at least a portion of the body ply. The tire also includes a pair of reinforcement fillers. Each reinforcement filler has an inner surface in contact with an outer surface of a respective bead filler. A bottom end of each reinforcement filler is disposed radially above a top end of a respective wire reinforcement. The tire further includes an electronic device disposed radially below the apex of the bead filler of one of the pair of bead portions.

### CROSS-REFERENCE TO RELATED APPLICATIONS

The present disclosure is a divisional of U.S. patent application Ser. No. 15/101,464, filed on Jun. 3, 2016, which is a 371 national stage entry of PCT/US2014/068696, filed on Dec. 5, 2014, which in turn claims the benefit of U.S. Provisional Patent Application No. 61/915,556, filed on Dec. 13, 2013. The disclosures of these references are incorporated herein in their entirety.

### FIELD OF INVENTION

The present disclosure relates to the field of incorporating an electronic device in a tire. More specifically, the present disclosure relates to the field of embedding a radio frequency identification (“RFID”) tag in a tire.

### BACKGROUND

Incorporation of an electronic device, such as an RFID tag, into a tire can occur during tire construction and before vulcanization or in a post-cure procedure. Such electronic devices have utility in transmitting data, such as tire-specific identification data, to an external reader. Ultra-high frequency (“UHF”) tags are typically small and utilize flexible antennas for the transmission of data. When embedded into a tire, such as during tire construction, the electronic device represents a foreign object that can affect the structural integrity of the tire. Many locations within a tire are not suitable for placing an RFID tag because of cyclical flexural bending in service or because the location does not permit suitable radio frequency compatibility for reading applications.

### SUMMARY OF THE INVENTION

In one embodiment, a tire includes a circumferential tread, a pair of sidewalls, and a pair of bead portions. Each of the pair of bead portions includes a bead and a bead filler having an apex. The tire further includes a body ply extending from bead portion to bead portion. The body ply includes a pair of turn up portions axially outside of a respective bead. The tire also has a pair of wire reinforcements. Each wire reinforcement wraps around a respective bead and at least a portion of the body ply. The tire further includes a pair of reinforcement fillers. Each reinforcement filler has an inner surface in contact with an outer surface of a respective bead filler. The tire further has a pair of abrasion portions. Each abrasion portion at least partially wraps around one of the pair of bead portions. The tire also has an electronic device disposed radially below the apex of the bead filler of one of the pair of bead portions. At least a portion of the electronic device is sandwiched between one of the pair of reinforcement fillers and a respective one of the pair of abrasion portions.

In another embodiment, a tire includes a circumferential tread, a first bead portion, and a second bead portion. The first bead portion includes a first bead and a first bead filler having a first apex. The second bead portion includes a second bead and a second bead filler having a second apex. The tire also has a first sidewall extending between the first bead portion and the circumferential tread and a second sidewall extending between the second bead portion and the circumferential tread. The tire further has a body ply extending from the first bead portion to the second bead portion. The body ply includes a first turn up portion axially outside of the first bead portion and a second turn up portion axially outside of the second bead portion. The tire further includes a first reinforcement filler having an inner surface in contact with an outer surface of the first bead filler, and a second reinforcement filler having an inner surface in contact with an outer surface of the second bead filler. The tire also includes a first abrasion portion at least partially wrapping around the first bead portion, and a second abrasion portion at least partially wrapping around the second bead portion. The tire further includes an electronic device disposed radially below the first apex of the first bead filler. The electronic device is sandwiched between the first reinforcement filler and the first abrasion portion, such that the electronic device is in contact with the first reinforcement filler and the first abrasion portion.

In yet another embodiment, a tire includes a circumferential tread, a pair of sidewalls, and a pair of bead portions. Each bead portion includes a bead and a bead filler having an apex. The tire also has a body ply extending from bead portion to bead portion. The body ply includes a pair of turn up portions radially outside of a respective bead portion. The tire further has a pair of wire reinforcements. Each wire reinforcement wraps around a respective bead and at least a portion of the body ply. The tire also includes a pair of reinforcement fillers. Each reinforcement filler has an inner surface in contact with an outer surface of a respective bead filler. A bottom end of each reinforcement filler is disposed radially above a top end of a respective wire reinforcement. The tire further includes an electronic device disposed radially below the apex of the bead filler of one of the pair of bead portions.

### BRIEF DESCRIPTION OF THE DRAWINGS

In the accompanying drawings, structures are illustrated that, together with the detailed description provided below, describe exemplary embodiments of the claimed invention. Like elements are identified with the same reference numerals. It should be understood that elements shown as a single component may be replaced with multiple components, and elements shown as multiple components may be replaced with a single component. The drawings are not to scale and the proportion of certain elements may be exaggerated for the purpose of illustration.

FIG. 1 is a cross section of one embodiment of a tire 100 having an electronic device embedded therein;

FIG. 2 is a schematic drawing of one embodiment of an electronic device;

FIG. 3 is a cross section of the bead region of the tire 100;

FIG. 4 is a cross section of an alternative embodiment of a bead region of a tire; and

FIG. 5 is a cross section of another alternative embodiment of a bead region of a tire.

### DETAILED DESCRIPTION

The following includes definitions of selected terms employed herein. The definitions include various examples or forms of components that fall within the scope of a term and that may be used for implementation. The examples are not intended to be limiting. Both singular and plural forms of terms may be within the definitions.

“Axial” or “axially” refer to a direction that is parallel to the axis of rotation of a tire.

“Bead” refers to the part of the tire that contacts the wheel and defines a boundary of the sidewall.

“Circumferential” and “circumferentially” refer to a direction extending along the perimeter of the surface of the tread perpendicular to the axial direction.

“Equatorial plane” refers to the plane that is perpendicular to the tire's axis of rotation and passes through the center of the tire's tread.

“Radial” and “radially” refer to a direction perpendicular to the axis of rotation of a tire.

“Sidewall” refers to that portion of the tire between the tread and the bead.

“Tread” refers to that portion of the tire that comes into contact with the road under normal inflation and load.

Directions are stated herein with reference to the axis of rotation of the tire. The terms “upward” and “upwardly” refer to a general direction towards the tread of the tire, whereas “downward” and “downwardly” refer to the general direction towards the axis of rotation of the tire. Thus, when relative directional terms such as “upper” and “lower” or “top” and “bottom” are used in connection with an element, the “upper” or “top” element is spaced closer to the tread than the “lower” or “bottom” element. Additionally, when relative directional terms such as “above” or “below” are used in connection with an element, an element that is “above” another element is closer to the tread than the other element.

The terms “inward” and “inwardly” refer to a general direction towards the equatorial plane of the tire, whereas “outward” and “outwardly” refer to a general direction away from the equatorial plane of the tire and towards the sidewall of the tire. Thus, when relative directional terms such as “inner” and “outer” are used in connection with an element, the “inner” element is spaced closer to the equatorial plane of the tire than the “outer” element.

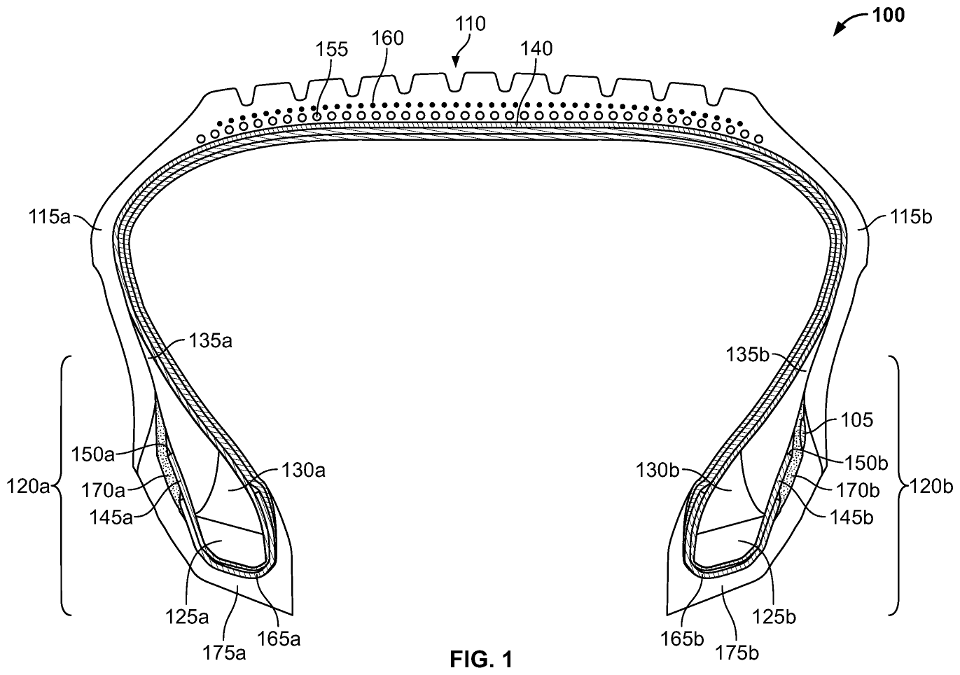

FIG. 1 illustrates a cross section of one embodiment of a tire 100 having an electronic device 105 embedded therein. In the illustrated embodiment, the tire 100 includes a circumferential tread 110 and a pair of sidewalls 115 including a first sidewall 115a and a second sidewall 115b. The first sidewall 115a extends from a first bead region 120a to the circumferential tread 110. The second sidewall 115b likewise extends from a second bead region 120b to the circumferential tread 110. Each bead region includes a bead 125a,b and a bead filler 130a,b having an apex 135a,b.

The tire 100 further includes a body ply 140 extending from the first bead region 120a to the second bead region 120b. While only a single body ply 140 is shown in the illustrated embodiment, it should be understood that two or more body plies may be employed.

The body ply 140 wraps around each of the beads 125a,b, thereby forming a first turn up portion 145a and a second turn up portion 145b. The first turn up portion 145a terminates at a first turn up end 150a located axially outside of the first bead filler 130a and radially below the apex 135a of the first bead filler 130a. Likewise, the second turn up portion 145b terminates at a second turn up end 150b located axially outside of the second bead filler 130b and radially below the apex 135b of the second bead filler 130a.

In the illustrated embodiment, the tire 100 further includes a belt 155 and a cap ply 160. In an alternative embodiment (not shown), the tire may include two or more belts. In another alternative embodiment (not shown), the tire may include two or more cap plies. In yet another alternative embodiment (not shown), the cap ply may be omitted.

With continued reference to FIG. 1, the tire 100 further includes a first wire reinforcement 165a in the first bead region 120a and a second wire reinforcement 165b in the second bead region 120b. Each wire reinforcement 165a,b wraps around the respective bead 125a,b and part of the respective bead filler 130a,b and body ply 140. The wire reinforcements 165a,b may provide a structural reinforcement to the tire 100, or it may protect the body ply 140 from abrasion. However, it should be understood that the wire reinforcements 165a,b need not serve such functions. In an alternative embodiment (not shown), the wire reinforcement may be omitted.

The tire 100 also includes a pair of reinforcement fillers 170, including a first reinforcement filler 170a located axially outside of the first bead filler 130a and a second reinforcement filler 170b located axially outside of the second bead filler 130b. Each reinforcement filler 170a,b has a top end disposed below the apex 135a,b of the respective bead filler 130a,b and radially above the turn up end 150a,b of the respective turn up portion 145a,b of the body ply 140.

The tire 100 further includes a pair of abrasion portions 175, including a first abrasion portion 175a and a second abrasion portion 175b. Each abrasion portion 175 at least partially wraps around a bead 125 and bead filler 130 such that each abrasion portion includes a first portion disposed axially outside a respective bead filler 130, reinforcement filler 170, and turn up portion 145 of the body ply 140. Each abrasion portion 175 further includes a second portion disposed below a respective bead 125.

The electronic device 105 is disposed in one of the bead regions 120 at a location radially below the apex 135 of the respective bead filler 130 and axially outside the bead filler 130. The electronic device 105 is axially spaced from the bead filler 130 such that the electronic device 105 does not contact the bead filler 130. While the illustrated embodiment shows the electronic device 105 disposed on the right side of the tire 100, it should be understood that the electronic device may be disposed on either side of the tire. It should be further understood that a tire could have multiple electronic devices, as one device disposed on each side of the tire.

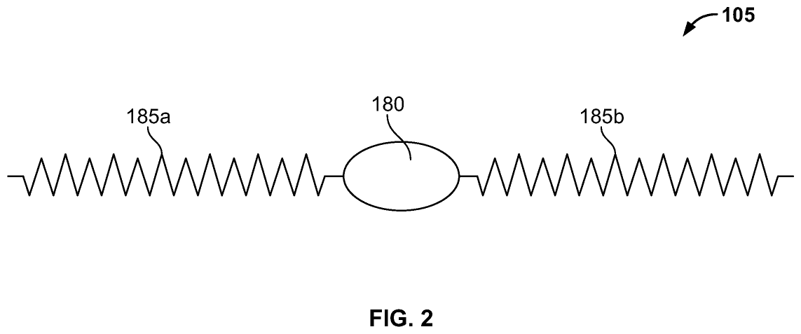

FIG. 2 is a schematic drawing of one embodiment of an electronic device 105. In the illustrated embodiment, the electronic device 105 is an RFID tag having a passive RFID transponder 180 and a pair of antennae 185a,b forming a dipole. The RFID tag may be embedded in a material, such as rubber or another polymeric material. Alternatively, a bare RFID tag may be employed. It should be understood, however, that the illustrated embodiment is merely exemplary, and any electronic device may be employed.

In one embodiment, the electronic device 105 is oriented in a substantially circumferential direction.

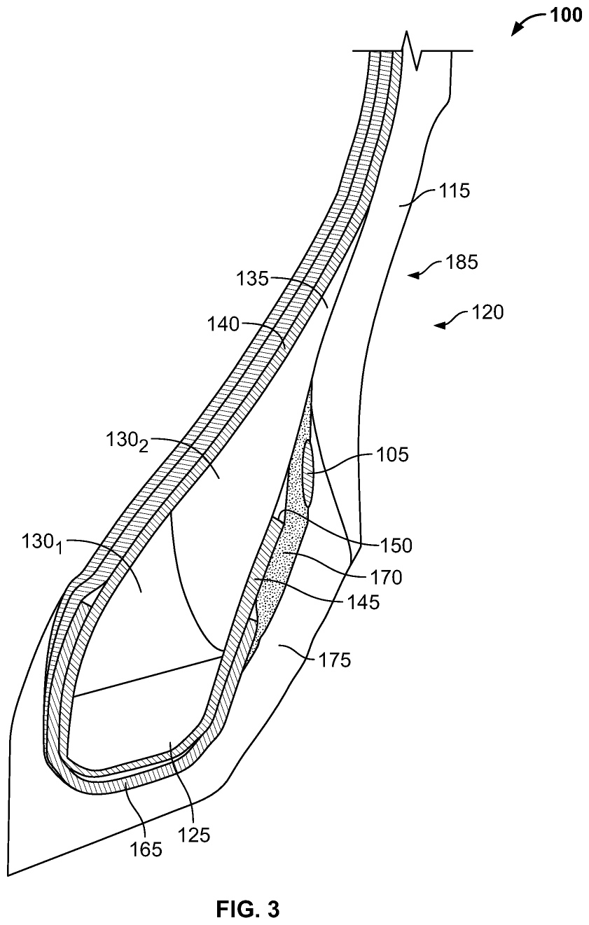

FIG. 3 illustrates a cross section of one of the bead regions 120 of the tire 100. As can be seen in this illustration, the wire reinforcement 165 wraps around the bead 125 and partially wraps around the bead filler 130 such that the wire reinforcement 165 has an inner portion axially inside the body ply 140 and an outer portion axially outside the turn up portion 145 of the body ply 140. The inner portion of the wire reinforcement 165 has an inner end terminating radially above the bead 125 and radially below the apex 135 of the bead filler 130. The outer portion of the wire reinforcement 165 has an outer end radially above the bead 125 and radially below the turn up end 150 of the turn up portion 145 of the body ply 140. However, it should be understood that the illustrated wire reinforcement is merely exemplary, and that the inner and outer ends may be disposed at any location. In an alternative embodiment (not shown), the wire reinforcement may be omitted.

With continued reference to FIG. 3, the reinforcement filler 170 has an inner surface with an upper portion contacting an outer surface of the bead filler 130, a middle portion contacting an outer surface of the turn up portion 145 of the body ply 140, and a lower portion contacting an outer surface of the wire reinforcement 165. The electronic device 105 is sandwiched between the reinforcement filler 170 and the abrasion portion 175, such that the electronic device 105 contacts both the reinforcement filler 170 and the abrasion portion 175. The electronic device 105 is disposed radially above the turn up end 150 of the turn up portion 145 of the body ply 140. In an alternative embodiment (not shown), at least a portion of the electronic device 105 is radially below the turn up end of the turn up portion of the body ply. In another alternative embodiment (not shown), the electronic device may be spaced from one or both of the reinforcement filler and the abrasion portion. In yet another alternative embodiment (not shown), a lower portion of the electronic device is sandwiched between the reinforcement filler and the abrasion portion while an upper portion of the electronic device is sandwiched between the sidewall and the bead filler.

In the illustrated embodiment, the upper end of the abrasion portion 175 is sandwiched between the reinforcement filler 170 and a lower end of the sidewall 115. In an alternative embodiment (not shown), the lower end of the sidewall may instead be sandwiched between the reinforcement filler and the upper end of the abrasion portion. In such an embodiment, at least a portion of the electronic device may be sandwiched between the sidewall and the reinforcement filler.

In the illustrated embodiment, an upper portion of the abrasion portion 175 is disposed between the reinforcement filler 170 and the sidewall 115, such that the abrasion portion 175 is in contact with the reinforcement filler 170 and the sidewall 115. In an alternative embodiment (not shown), the abrasion portion may be spaced from one or both of the reinforcement filler and the sidewall.

With continued reference to FIG. 3, a portion of the sidewall 115 includes a concave outer surface 190. In an alternative embodiment (not shown), the sidewall does not include this concave section.

In the illustrated embodiment, the bead filler 130 includes a first portion 130₁ constructed of a first material and a second portion 130₂ constructed of a second material, the first material being harder than the second material. The first portion 130₁ is disposed between the bead 125 and the second portion 130₂. In an alternative embodiment, the bead filler may be constructed of a single material. In another alternative embodiment, the bead filler may have three or more portions constructed of different materials.

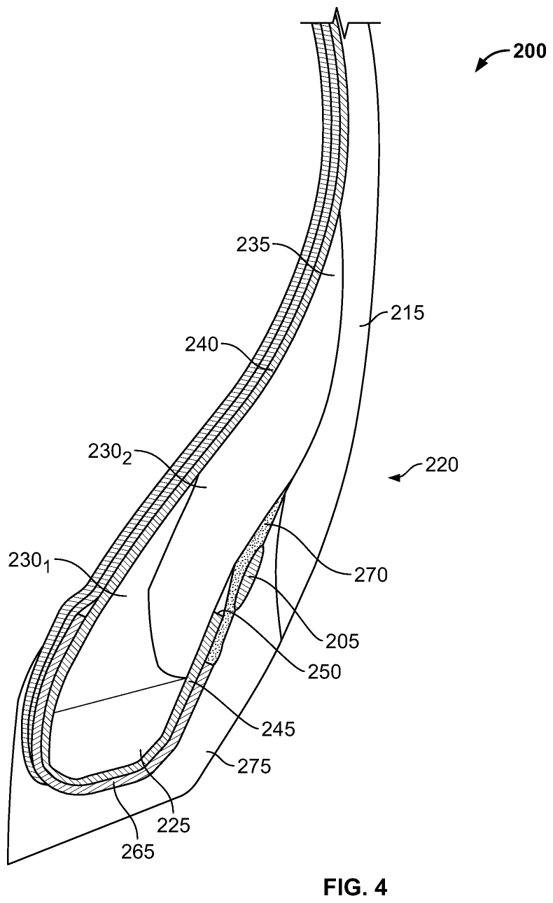

FIG. 4 illustrates a cross section of a portion of an alternative embodiment of a tire 200 having an electronic device 205. As can be seen in this illustration, this portion of the tire 200 is substantially similar to the bead region 120 of the tire 100, except the sidewall 215 does not include a concave portion.

A bead region 220 of the tire 200 is illustrated. The bead region 220 includes a bead 225 and a bead filler 230 having an apex 235. The tire 200 further includes a body ply 240 having a turn up portion 245 and a turn up end 250. A wire reinforcement 265 wraps around the bead 225 and partially wraps around the bead filler 230 such that the wire reinforcement 265 has an inner portion axially inside the body ply 240 and an outer portion axially outside the turn up portion 245 of the body ply 240. The inner portion of the wire reinforcement 265 has an inner end terminating radially above the bead 225 and radially below the apex 235 of the bead filler 230. The outer portion of the wire reinforcement 265 has an outer end radially above the bead 225 and radially below the turn up end 250 of the turn up portion 245 of the body ply 240. However, it should be understood that the illustrated wire reinforcement is merely exemplary, and that the inner and outer ends may be disposed at any location. In an alternative embodiment (not shown), the wire reinforcement may be omitted.

With continued reference to FIG. 4, a reinforcement filler 270 has an inner surface with an upper portion contacting an outer surface of the bead filler 230, a middle portion contacting an outer surface of the turn up portion 245 of the body ply 240, and a lower portion contacting an outer surface of the wire reinforcement 265. The electronic device 205 is sandwiched between the reinforcement filler 270 and an abrasion portion 275, such that the electronic device 205 contacts both the reinforcement filler 270 and the abrasion portion 275. The electronic device 205 is disposed radially above the turn up end 250 of the turn up portion 245 of the body ply 240. In an alternative embodiment (not shown), at least a portion of the electronic device 205 is radially below the turn up end of the turn up portion of the body ply. In another alternative embodiment (not shown), the electronic device may be spaced from one or both of the reinforcement filler and the abrasion portion.

In the illustrated embodiment, an upper portion of the abrasion portion 275 is disposed between the reinforcement filler 270 and the sidewall 215, such that the abrasion portion 275 is in contact with the reinforcement filler 270 and the sidewall 215. In an alternative embodiment (not shown), the abrasion portion may be spaced from one or both of the reinforcement filler and the sidewall.

In the illustrated embodiment, the bead filler 230 includes a first portion 230₁ constructed of a first material and a second portion 230₂ constructed of a second material, the first material being harder than the second material. The first portion 230₁ is disposed between the bead 225 and the second portion 230₂. In an alternative embodiment, the bead filler may be constructed of a single material. In another alternative embodiment, the bead filler may have three or more portions constructed of different materials.

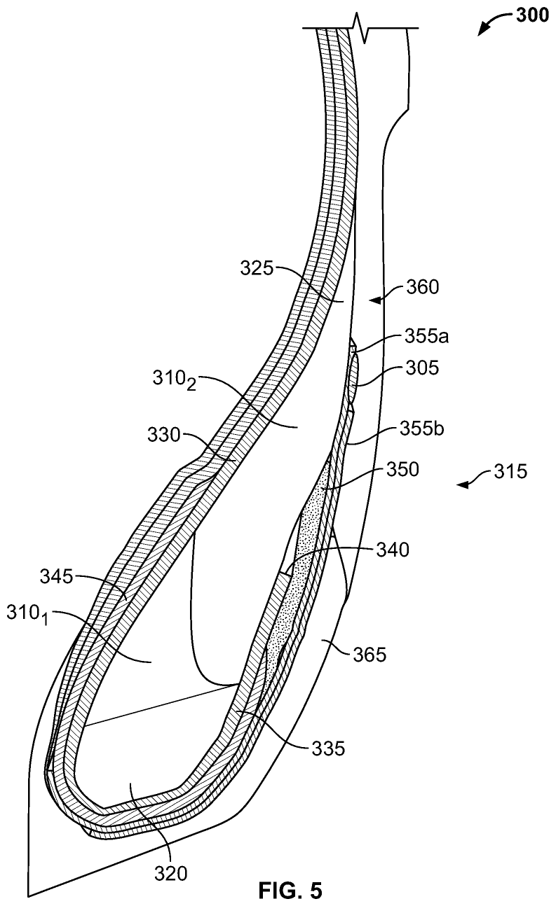

FIG. 5 illustrates a cross section of a portion of another alternative embodiment of a tire 300 having an electronic device 305 spaced from a bead filler 310. While only a bead region 315 of the tire 300 is shown, it should be understood that that the tire 300 may share the features of tire 100 illustrated in FIG. 1, except for the differences described below.

The bead region 315 includes a bead 320 and the bead filler 310. The bead filler 310 has an apex 325. The bead filler 310 includes a first portion 310₁ constructed of a first material and a second portion 310₂ constructed of a second material, the first material being harder than the second material. The first portion 310₁ is disposed between the bead 320 and the second portion 310₂. In an alternative embodiment, the bead filler may be constructed of a single material. In another alternative embodiment, the bead filler may have three or more portions constructed of different materials.

A body ply 330 wraps around the bead 320 and a portion of the bead filler 310, such that a turn up portion 335 terminates at a turn up end 340 axially outside of the bead 320 and radially below the apex 325 of the bead filler 310.

A wire reinforcement 345 partially wraps around the bead 320 and the bead filler 310 such that the wire reinforcement 345 has an inner portion axially inside the body ply 330 and an outer portion axially outside the turn up portion 335 of the body ply 330. The inner portion of the wire reinforcement 345 has an inner end disposed radially above the bead 320 and radially below the apex 325 of the bead filler 310. The outer portion of the wire reinforcement 345 has an outer end radially above the bead 320 and radially below the turn up end 340 of the turn up portion 335 of the body ply 330. However, it should be understood that the illustrated wire reinforcement is merely exemplary, and that the inner and outer ends may be disposed at any location. In an alternative embodiment (not shown), the wire reinforcement may be omitted.

The bead region 315 of the tire 300 further includes a reinforcement filler 350. The reinforcement filler 350 has an inner surface with an upper portion contacting an outer surface of the bead filler 310, a middle portion contacting an outer surface of the turn up portion 335 of the body ply 330, and a lower portion contacting an outer surface of the wire reinforcement 345. The reinforcement filler 350 has a top end disposed below the apex 325 of the bead filler 310.

The bead region 315 further includes a pair of chafers 355, including a first chafer 355a and a second chafer 355b disposed outside of the first chafer 355a. The pair of chafers 355 at least partially wrap around the bead 320 and bead filler 310, such that the pair of chafers 355 includes a first portion disposed axially outside the bead filler 310, the reinforcement filler 350, and the turn up portion 335 of the body ply 330. The pair of chafers further includes a second portion disposed below the bead 320.

While two chafers are shown in the illustrated embodiment, it should be understood that a single chafer may be employed in an alternative embodiment. In another alternative embodiment (not shown), three or more chafers may be employed.

In the illustrated embodiment, the first chafer 355a has a first outer end and the second chafer 355b has a second outer end located radially below the first outer end of the first chafer 355a. In an alternative embodiment (not shown), the first chafer and second chafer have outer ends that terminate at the same radial height. In another alternative embodiment (not shown), the first chafer has a first outer end located radially below the second outer end of the second chafer.

The first chafer 355a is disposed between the electronic device 305 and the bead filler 310, such that the electronic device 305 is sandwiched between the first portion of the first chafer 355a and a sidewall 360. The electronic device 305 is disposed at a location radially below the first outer end of the first chafer 355a and radially above the second outer end of the second chafer 355b. In an alternative embodiment (not shown), at least a portion of the electronic device is disposed below the second outer end of the second chafer 355b.

In the illustrated embodiment, the first chafer 355a contacts the electronic device 305 and the second chafer 355b does not contact the electronic device 305. In an alternative embodiment (not shown), both the first chafer and the second chafer contact the electronic device. In another alternative embodiment (not shown), the second chafer contacts the electronic device, but the first chafer does not. In yet another alternative embodiment (not shown), the electronic device is spaced from both the first and second chafers.

The bead region 315 further includes an abrasion portion 365 that at least partially wraps around the bead 320 and bead filler 310. In the illustrated embodiment, the upper end of the abrasion portion 365 is sandwiched between the second chafer 355b and a lower end of the sidewall 360. In an alternative embodiment (not shown), the lower end of the sidewall may instead be sandwiched between the second chafer and the upper end of the abrasion portion. In another alternative embodiment (not shown), the abrasion portion may be omitted, and the sidewall rubber may extend around the bead region.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components.

While the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the application, in its broader aspects, is not limited to the specific details, the representative apparatus and method, and illustrative examples shown and described. Accordingly, departures may be made from such details without departing from the spirit or scope of the applicant's general inventive concept.

What is claimed is:

1. A tire comprising:
a circumferential tread;
a pair of sidewalls;
a pair of bead portions, each of the pair of bead portions including a bead and a bead filler having an apex;
a body ply extending from bead portion to bead portion, the body ply including a pair of turn up portions axially outside of a respective bead;
a pair of wire reinforcements, each wire reinforcement wrapping around a respective bead and at least a portion of the body ply;
a pair of reinforcement fillers, each reinforcement filler having an inner surface in contact with an outer surface of a respective bead filler;
a pair of abrasion portions, each abrasion portion at least partially wrapping around one of the pair of bead portions; and
an electronic device disposed radially below the apex of the bead filler of one of the pair of bead portions, wherein at least a portion of the electronic device is sandwiched between one of the pair of reinforcement fillers and a respective one of the pair of abrasion portions.

2. The tire of claim 1, further comprising a pair of chafers, including a first chafer at least partially wrapping around a first bead of the pair of bead portions and further including a second chafer at least partially wrapping around a second bead of the pair of bead portions.

3. The tire of claim 2, further comprising a second pair of chafers, including a third chafer at least partially wrapping around the first chafer and further including a fourth chafer at least partially wrapping around the second chafer.

4. The tire of claim 1, wherein a bottom end of each reinforcement filler is disposed radially above a top end of a respective wire reinforcement.

5. The tire of claim 1, wherein a bottom end of each reinforcement filler extends radially below a top end a respective wire reinforcement.

6. The tire of claim 5, wherein the bottom end of each reinforcement filler extends axially outside the top end the respective wire reinforcement.

7. The tire of claim 1, wherein the electronic device is a radio frequency identification tag.

8. A tire comprising:
a circumferential tread;
a first bead portion, including a first bead and a first bead filler having a first apex;
a second bead portion, including a second bead and a second bead filler having a second apex;
a first sidewall extending between the first bead portion and the circumferential tread;
a second sidewall extending between the second bead portion and the circumferential tread;
a body ply extending from the first bead portion to the second bead portion, the body ply including a first turn up portion axially outside of the first bead portion and a second turn up portion axially outside of the second bead portion;
a first reinforcement filler having an inner surface in contact with an outer surface of the first bead filler;
a second reinforcement filler having an inner surface in contact with an outer surface of the second bead filler;
a first abrasion portion at least partially wrapping around the first bead portion;
a second abrasion portion at least partially wrapping around the second bead portion;
an electronic device disposed radially below the first apex of the first bead filler, wherein the electronic device is sandwiched between the first reinforcement filler and the first abrasion portion, such that the electronic device is in contact with the first reinforcement filler and the first abrasion portion.

9. The tire of claim 8, wherein an upper portion of the first abrasion portion is sandwiched between the first reinforcement filler and the first sidewall, such that the first abrasion portion is in contact with the first reinforcement filler and the first sidewall, and wherein an upper portion of the second abrasion portion is sandwiched between the second reinforcement filler and the second sidewall, such that the second abrasion portion is in contact with the second reinforcement filler and the second sidewall.

10. The tire of claim 8, wherein the first turn up portion terminates at a first turn up end disposed radially below a top end of the first reinforcement filler, and wherein the second turn up portion terminates at a second turn up end disposed radially below a top end of the second reinforcement filler.

11. The tire of claim 10, wherein the electronic device is disposed radially above the first turn up end, and wherein the electronic device is spaced axially outward from the first turn up portion.

12. The tire of claim 8, further comprising a first wire reinforcement wrapped around the first bead and at least a portion of the body ply, and a second wire reinforcement wrapped around the second bead and at least a portion of the body ply.

13. The tire of claim 12, wherein an inner surface of the first reinforcement filler includes an upper portion contacting an outer surface of the first bead filler, a middle portion contacting an outer surface of the first turn up portion of the body ply, and a lower portion contacting an outer surface of the first wire reinforcement, and wherein an inner surface of the second reinforcement filler includes an upper portion contacting an outer surface of the second bead filler, a middle portion contacting an outer surface of the second turn up portion of the body ply, and a lower portion contacting an outer surface of the second wire reinforcement.

14. The tire of claim 8, wherein the first reinforcement filler has a top end located below the first apex of the first bead filler, and wherein the second reinforcement filler has a top end located below the second apex of the second bead filler.

15. The tire of claim 8, wherein the first sidewall includes a concave outer surface, and wherein the second sidewall includes a concave outer surface.

16. A tire comprising:
a circumferential tread;
a pair of sidewalls;
a pair of bead portions, wherein each bead portion includes a bead and a bead filler having an apex;
a body ply extending from bead portion to bead portion, the body ply including a pair of turn up portions radially outside of a respective bead portion;
a pair of wire reinforcements, each wire reinforcement wrapping around a respective bead and at least a portion of the body ply;
a pair of reinforcement fillers, each reinforcement filler having an inner surface in contact with an outer surface of a respective bead filler, wherein a bottom end of each reinforcement filler is disposed radially above a top end of a respective wire reinforcement; and
an electronic device disposed radially below the apex of the bead filler of one of the pair of bead portions.

17. The tire of claim 16, further comprising a pair of abrasion portions, each abrasion portion at least partially wrapping around one of the pair of bead portions.

18. The tire of claim 17, wherein at least a portion of the electronic device is sandwiched between one of the pair of reinforcement fillers and one of the pair of abrasion portions.

19. The tire of claim 18, wherein the electronic device is in contact with the one of the pair of reinforcement fillers and the one of the pair of abrasion portions.

20. The tire of claim 16, wherein the electronic device does not contact the bead filler of either of the pair of bead portions.
